(19) United States
(12) Patent Application Publication
(10) Pub. No.: US 2008/0065639 A1
(43) Pub. Date: Mar. 13, 2008

(54) STRING MATCHING ENGINE

(75) Inventors: Ashwini Choudhary, San Jose, CA (US); Pranav Ashar, Belle Mead, NJ (US); Jitendra Kulkarni, San Jose, CA (US)

Correspondence Address: BEYER WEAVER LLP, P.O. BOX 70250, OAKLAND, CA, 94612-0250, US

(73) Assignee: NetFortis, Inc., MountainView, CA (US)

(21) Appl. No.: 11/550,320

(22) Filed: Oct. 17, 2006

Related U.S. Application Data
(60) Provisional application No. 60/840,168, filed on Aug. 25, 2006.

(51) Int. Cl. G06F 7/00

(52) U.S. Cl. 707/7

(57) ABSTRACT

String matching a first string to a string stored in a string dictionary is performed by k-way hashing the first string and locating corresponding k hash locations in a first memory. When any of the k hash locations has a zero Bloom bit, the first string is deemed to not match any of the strings in the string dictionary. Otherwise, a sub-set of the k hash locations identified as those k hash locations having non-zero Bloom bits and a unique bit set to 1 each include a pointer that points to a string in the string dictionary that is fetched and compared to the first string wherein the fetches from the string dictionary are interleaved over the addresses from the first memory. A match signal is issued when the first string matches at least one of the strings stored in the dictionary.

### CROSS REFERENCE TO RELATED APPLICATIONS

This patent application takes priority under 35 U.S.C. 119(e) to (i) U.S. Provisional Patent Application No. 60/840,168, filed on Aug. 25, 2006 (Attorney Docket No. NETFP001P) entitled “STRING MATCHING ENGINE” by Choudhary et al. This application is also related to (i) co-pending application entitled, “STRING MATCHING ENGINE FOR ARBITRARY LENGTH STRINGS” by Ashar et al (Attorney Docket No. NETFP002) having application Ser. No. ______ and filed ______ and (ii), co-pending application entitled, “REGULAR EXPRESSION MATCHING ENGINE” by Ashar et al (Attorney Docket No. NETFP003) having application Ser. No. ______ and filed ______ each of which are incorporated by reference in their entirety for all purposes.

### BACKGROUND

1. Field of the Invention

The invention relates to string matching engine technology.

2. Description of Related Art

String matching is a core algorithm in a number of important applications. The basic problem is to efficiently detect if one or more strings in a predefined dictionary is contained in an input character data stream. A simplistic string-searching algorithm is illustrated in Table 1.

TABLE 1

1 function NaiveSearch(string s[1..n], string sub[1..m])
2 for i from 1 to n
3 for j from 1 to m
4 if s[i+j−1] ≠ sub[j]
5 jump to next iteration of outer loop
6 return i
7 return not found

It should be noted that the simple string searching algorithm requires substantial computing and memory resources since it is O(nm) for each dictionary string, where n is the length of the input data stream and m is the length of the dictionary string. (O is a mathematical notation used to describe the asymptotic behavior of functions for very large (or very small) inputs.)

Various techniques have been proposed to reduce this complexity. Four notable examples are:

(1) Rabin-Karp

(2) Knuth-Morris-Pratt

(3) Boyer-Moore

(4) Aho-Corasick (Finite Automaton)

The Rabin-Karp algorithm hashes the input data stream segment and looks it up against the dictionary string before performing an actual character-by-character comparison. In addition, it uses a rolling hash that allows it to compute in O(l) time the hash of a new segment of the input stream incrementally from the hash of the old segment. Also, the lookup can be performed against a table containing more than one dictionary string. As a result, the Rabin-Karp algorithm is suited for string matching against a multiple-string dictionary. The average case complexity is O(n). The limitations of this algorithm are the O(nm) worst-case complexity and complications when matching against a dictionary with strings of different lengths. The Boyer-Moore and Knuth-Morris-Pratt algorithms advance the input stream by more than one character based on pre-computed characteristics of the dictionary string. Both have good complexity characteristics, with Boyer-Moore being able to achieve O(n/m) in the average case. The limitations of both are that they are suited primarily for matching against single strings.

Finite-automaton based methods model a dictionary string as a state machine, and the string-matching problem is modeled as one of traversing the state machine to an accepting state. The Aho-Corasick algorithm optimizes the state machine for a multiplicity of dictionary strings and allows finding all possible matches of the input stream against the dictionary strings. The complexity of the Aho-Corasick algorithm is O(n) for matching against the entire dictionary. The algorithms have the limitation that the state machine modeling the dictionary strings tends to grow rather rapidly. Implementing such large state machines in software or conventional logic based hardware results in very low performance and very high code or area/power overheads. As a result, practical implementations tend to match against small sections of the dictionary at a time, increasing the complexity from the ideal O(n).

Accordingly, what is needed is a system and method to address the above-identified problems. The present invention addresses such a need.

### SUMMARY OF DESCRIBED EMBODIMENTS

Broadly speaking, the invention relates to efficient string matching using a low memory collision-free hash-based look up scheme with low average case bandwidth and power requirements that overcomes prior art limitations by providing the ability to match against a large dictionary of long and arbitrary length strings at line speed. It should be noted that in the context of the described embodiments, a string can take many forms, such as a set of characters, bits, numbers or any combination thereof.

A method of string matching is described by k-way hashing a first string, locating k hash locations in first memory based upon the k-way hashing, identifying a set of the k addresses having a corresponding string stored in a second memory, comparing the first string to the stored strings, and issuing a match signal when the first string and at least one of the stored strings matches. In one embodiment, the first memory is formed of rows arranged to stored data bits arranged in a first data field for storing a Bloom bit, a second data field for storing a unique bit that is used to determine which of the k hash locations hold a useful address, and a third data field for storing a pointer arranged to point to an address in the second memory used to store the corresponding string, wherein if any of the Bloom bits associated with the k hash locations is zero, then the first string does not match any of the stored strings, and wherein the sub-set of k hash locations are those k hash locations having no zero Bloom bits.

Computer program product executable by a computer processor for string matching is described. The computer program product includes computer code for by k-way hashing a first string, locating k hash locations in a first memory based upon the k-way hashing, identifying a set of the k hash locations having a corresponding string stored in a second memory, comparing the first string to the stored strings, and issuing a match signal when the first string and at least one of the stored strings matches.

In one embodiment, the first memory is formed of rows arranged to stored data bits arranged in a first data field for storing a Bloom bit, a second data field for storing a unique bit that is used to determine which of the k hash locations hold a useful address, and a third data field for storing a pointer arranged to point to an address in the second memory used to store the corresponding string, wherein if any of the Bloom bits associated with the k hash locations is zero, then the first string does not match any of the stored strings, and wherein the sub-set of k hash locations are those k hash locations having no zero Bloom bits.

An apparatus for string matching is described that includes means for k-way hashing a first string, locating k hash locations in a first memory based upon the k-way hashing, identifying a set of the k hash locations having a corresponding string stored in a second memory, comparing the first string to the stored strings, and issuing a match signal when the first string and at least one of the stored strings matches.

In one embodiment, the first memory is formed of rows arranged to stored data bits arranged in a first data field for storing a Bloom bit, a second data field for storing a unique bit that is used to determine which of the k hash locations hold a useful address, and a third data field for storing a pointer arranged to point to an address in the second memory used to store the corresponding string, wherein if any of the Bloom bits associated with the k hash locations is zero, then the first string does not match any of the stored strings, and wherein the sub-set of k hash locations are those k hash locations having no zero Bloom bits.

Other aspects and advantages of the invention will become apparent from the following detailed description taken in conjunction with the accompanying drawings.

### DESCRIPTION OF DRAWINGS

FIG. 1 depicts Cuckoo hashing where the various arrows show the alternative location of each key.

FIG. 2 shows an example of a personal communication device in accordance with an embodiment of the invention.

FIG. 3 shows a communication network suitable for implementing the invention.

FIG. 4 shows an implementation of the string-matching engine included in the co-processor.

FIG. 5 shows a particular implementation of the primary hash look up table in accordance with an embodiment of the invention.

FIG. 6 shows an exemplary memory row (hash bucket) and associated data fields in accordance with an embodiment of the invention.

FIG. 7 shows a flowchart detailing a process for creating the hash lookup table in accordance with an embodiment of the invention.

FIG. 8 illustrates a process 800 for updating the primary hash lookup table when a new entry is added to the string dictionary in accordance with an embodiment of the invention.

FIG. 9 shows a process for determining if a string of arbitrary length is stored in a string dictionary in accordance with an embodiment of the invention.

FIG. 10 shows a process for deleting an entry in the string dictionary in accordance with an embodiment of the invention.

### DETAILED DESCRIPTION OF SELECTED EMBODIMENTS

Reference will now be made in detail to a particular embodiment of the invention an example of which is illustrated in the accompanying drawings. While the invention will be described in conjunction with the particular embodiment, it will be understood that it is not intended to limit the invention to the described embodiment. To the contrary, it is intended to cover alternatives, modifications, and equivalents as may be included within the spirit and scope of the invention as defined by the appended claims.

Previous string matching techniques have had one or more of the disadvantages of false positives, high memory bandwidth requirement, large memory requirement, and unpredictable lookup latency. The described string-matching engine overcomes these drawbacks with a low memory and logic requirement using a combination of up front filtering to detect a mismatch (based, in part, upon the Bloom filter approach) followed by a low-memory, low-memory-bandwidth, high-speed mechanism to avoid false positives. In this way, the described string matching engine provides for efficient string matching using a low memory collision-free hash-based look up scheme with low average case bandwidth and power requirements that overcomes prior art limitations by providing the ability to match against a large dictionary of long and arbitrary length strings at line speed.

Generally speaking, the described embodiments utilize a primary memory (configured as a hash lookup table) arranged to store a transitively unique address identified for each dictionary entry S (character strings of arbitrary length) stored in a secondary memory. For every dictionary entry, an entry addition into the primary memory is performed by first checking if any hashed row for the entry to be added into the primary memory is not already being used as a unique bit by another entry. If such a row is not found, then the already existing entry that is colliding with the new entry is transferred to an alternate location when no unique address is found for the new entry. What is referred to as a unique bit (b₀) at each primary memory address is used to mark the use of that particular address as a unique location corresponding to a particular dictionary entry. A second bit (or collection of bits (b₁ to bₓ)) may be used to indicate if that primary memory address was hashed to by any other element of S as well as provide a counter that facilitates dictionary entry deletion. A third set of bits (bₓ₊₁ to b_{x+w}) at a memory address location stores the address pointing to the secondary memory where the input key (or key-fingerprint) and any data associated with the key is stored.

In order to facilitate the understanding of the description of selected embodiments, a brief discussion of hashing is presented.

The original hash-based architecture consists of a hash function H(i), a table T (nominally an array), and a bucket B (nominally a linked list) stored at each row of the table. Each row of the table has an address associated with it using which the row can be accessed. In the typical lookup scheme, the input (nominally called the key) is mapped into a table address using the hash function. Hash functions are designed to provide a random distribution over the range of table addresses. The more uniform the distribution (for the set S in particular), the better the hash function. The size of the table T, |T|=m is generally greater than the size of the set S, |S|=n. In the typical hash function, multiple inputs in and external to S may map to the same table address. This is nominally called a collision. The bucket serves as the means to resolve collisions. Nominally, the bucket at an address contains a list of all the S elements (or, fingerprints derived from them) that map to that address. When a key maps to an address, the corresponding bucket is traversed to determine if the key (or its fingerprint) is stored in the bucket. If it is, the key is deemed to belong to S, otherwise it is not in S. Note that the bucket can also store any range value contiguous with the key/fingerprint to implement an arbitrary function.

One extension was the so-called perfect hash functions. A hash function is perfect if it maps each member of S to a unique address. With a perfect hash function the size of each bucket would be exactly one, and membership checking as well as function mapping could be done with predictable latency. An alternative to perfect hashing is the so-called “Cuckoo-hashing” scheme. In this scheme, two or more hash functions are used (the two-hash function version) and the key is hashed twice into the table. If neither address is unique to this key, the key is stored in one of the addresses and the existing key at that address is moved to its alternate address. This process is continued until a key gets moved to a vacant address. It has been demonstrated that if the size of the table is two or more times the size of S, the process completes in the typical case. The latency of lookups is predictable since each key requires only two hashes, and each bucket is of size one.

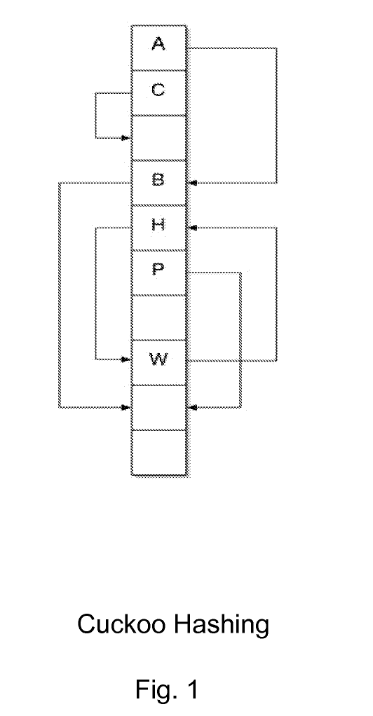

It has also been shown that insertions complete in expected constant time if |T|>=2×|S|. The performance can be improved by using more alternative locations (more hash functions). FIG. 1 depicts Cuckoo hashing where the various arrows show the alternative location of each key. A new item would be inserted in the location of A by moving A to its alternative location, currently occupied by B, and moving B to its alternative location which is currently vacant. Insertion of a new item in the location of H would not succeed: Since H is part of a cycle (together with W), the new item would get kicked out again. A disadvantage of cuckoo hashing is that the entire dictionary is stored in the primary (first) lookup table that the input keys hash into representing s a substantial overhead in memory.

A Bloom Filter allows membership queries with no false negatives, a very low memory requirement, and some other useful properties, but with the tradeoff that it allows false positives with a low, but finite, probability. The basic scheme uses multiple (k) hash functions. The table consists of one bit per address and is initialized with all 0s. During insertion, all the up to k addresses hashed to from a key are set to 1. During lookup, a key is said to be absent from S if any of its k addresses has a 0. If all k addresses have a 1, there is a very high probability that the key is in S. The probability of a false positive is approximately (0.62)^{m/n}, where m is the number of rows in the lookup table and n is the number of dictionary entries as before. For m/n=30, and k=5, the false positive probability is about 0.000036. Although this may seem small, this non-zero false positive probability is statistically significant considering the large amount of data being looked up. Note that since only one bit is used per address, the memory requirement is quite low relative to the size of the dictionary even with m/n=30. A useful property of the Bloom Filter is that the table does not contain any dictionary contents. This makes it suitable for applications requiring a high degree of security. Another advantage is that the low memory requirement of the lookup table means it can be broadcast over a network consuming much less bandwidth than it would have cost to broadcast the entire dictionary.

Unfortunately, a disadvantage of the Bloom Filter is that deletions from S are not possible. The Counting Bloom Filter was proposed to overcome this. Each address in the table now has a counter instead of just one bit. The counter is incremented during an insertion at that address and decremented during a deletion from that address. Unfortunately, however, the memory requirement is increased since the counter must have enough bits to prevent overflows.

Another approach referred to as a Bloomier Filter and variations can be thought of as a combination of Cuckoo hashing and the Bloom filter. There are k hash functions as in the Bloom Filter, but membership is based on a function computed from the values stored at the k hash addresses rather than the presence of a 0 at one of the addresses. The computed function is also used to point to a results table that stores the desired mapping from S to a range. Like the Cuckoo hashing scheme, the Bloomier Filter also relies on the availability of a transitively unique location per S element for collision-free hashing. The ability to map S to an arbitrary range is not a new contribution since all hash functions have this ability. Similarly, the use of the transitively unique location is also not new given its prior proposal in Cuckoo hashing. Unfortunately, the Bloomier Filter and its associated variations require either require a memory substantially bigger than the dictionary size for false positive resolution and function mapping, or require k multi-bit lookups in the primary hash table (the bit width of each lookup is the log of the number of entries in the dictionary), representing a substantial memory bandwidth and power requirement.

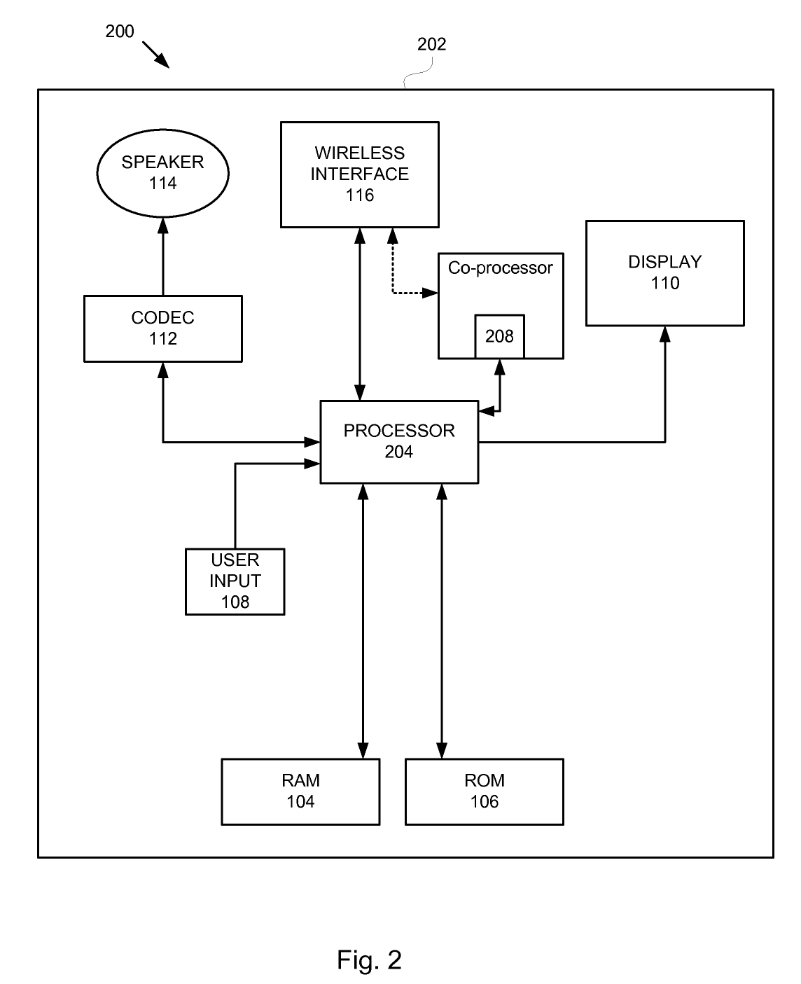

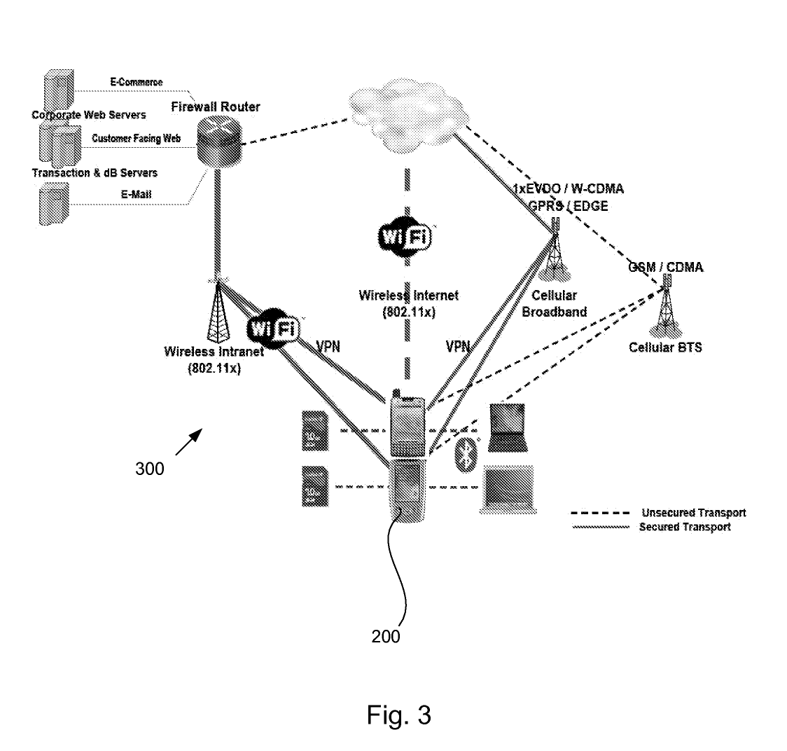

The described embodiments will now be described in terms of a string matching engine, system, and method useful in a number of applications where memory and computing resources are at a premium or, high performance is desired. Such applications are typically found in portable devices such as personal communication devices 200 (shown in FIG. 2) that include cell phones, PDAs, and other devices (referred to as thin client devices) having a comparatively small on board memory and limited processing capabilities that can be part of a communication network 300 illustrated in FIG. 3. As shown, the communication network 300 has a number of secure as well as unsecured communication channels. In the context of the communication network 300, the personal communication device 200 can be a potential target for a number of malware (or more commonly referred to in terms of viruses, worms, Trojan horses, etc.) that can severely impact the operation of the personal communication device 200.

The described string matching engine can be deployed as, or included in, a co-processor having its own memory and computing resources that are separate from a central processing unit, or CPU, arranged to filter any incoming traffic for character strings that have been identified as potential malware (i.e., a computer virus). In this way, malware detection can be off-loaded from the CPU thereby freeing up computing and memory resources otherwise required for detection of malware that would have the potential to severely disrupt the operation of the personal communication device 200. In some cases, the character strings are stored in a string dictionary and used by the string machine engine to detect such malware are supplied and periodically updated by a third party on either a subscription basis or as part of a service contract between a user and a service provider.

Referring back to FIG. 2, the personal communication device 200 in this example is a pocket sized cell phone 200 that provides the standard voice function of a telephone in addition to many additional services such as SMS for text messaging packet switching for access to the Internet and MMS for sending and receiving photos and video. The cell phone 200 is contained in a housing 202 that supports a processor 204 and a co-processor 206 (coupled to the processor 204) that includes a string-matching engine 208. (In some embodiments, the string matching engine 208 can take the form of a macro-program that is incorporated into the processor 204.) It should be noted that the described string-matching engine 208 can be used in any application whereby a low power, efficient (in both memory and computing resources) string-matching protocol is deemed appropriate. The processor 204 pertains to a microprocessor or controller for controlling the overall operation of the cell phone 200. The cell phone 200 further includes a RAM 210 that provides volatile data storage such as currently called phone numbers, ring tones, etc. and a Read-Only Memory (ROM) 212 arranged to store programs, utilities or processes to be executed in a non-volatile manner.

The cell phone 200 also includes a user input device 214 that allows a user to interact with the cell phone 200. For example, the user input device 214 can take a variety of forms, such as a button, keypad, dial, etc. Still further, the cell phone 200 includes a display 216 (screen display) that can be controlled by the processor 204 to display information to the user. A data bus can facilitate data transfer between at least the ROM 212, RAM 210, the processor 204, and a CODEC 218 that produces analog output signals for an audio output device 220 (such as a speaker). The speaker 220 can be a speaker internal to the cell phone 200 or external to the cell phone 200. For example, headphones or earphones that connect to the cell phone 200 would be considered an external speaker. A wireless interface 222 operates to receive information from the processor 204 that opens a channel (either voice or data) for transmission and reception typically using RF carrier waves.

During operation, the wireless interface 222 receives an RF transmission carrying an incoming data stream 224 in the form of data packets 226. Copies of the data packets are made and in some cases undergo additional processing prior to being forwarded to the co-processor 204 for examination by the string matching engine 208 for possible inclusion of character strings associated with known computer malware. In the described embodiment, the group of stored character strings (referred to as a string dictionary) used by the string matching engine 208 are provided by a third party and are periodically updated with new character strings in order to detect new computer malware. It should be noted that the string matching engine is capable of matching multiple tokens separated by a fixed or variable offset. Furthermore, the inputs to the string matching engine does not need to be derived solely from traffic. For example, inputs to the string matching engine can take the form of files already resident in the cell phone memory (RAM 210, ROM 212).

The string-matching engine 208 will provide a match flag 228 in those situations where the incoming data stream 224 includes a character string 230 that matches one of the entries in the string dictionary. The match flag 228 will notify the CPU 204 that the cell phone 200 has been exposed to potentially harmful computer malware and appropriate prophylactic measures must be taken. These measures can include malware sequestration, inoculation, quarantine, etc. provided by a security protocol.

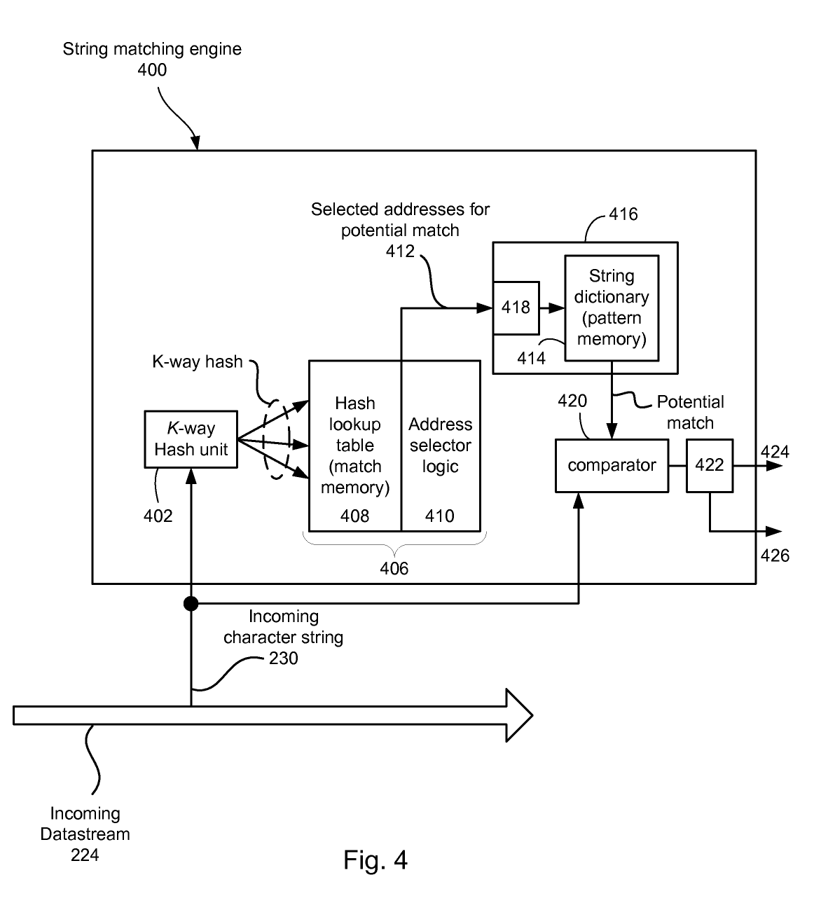

FIG. 4 shows a string-matching engine 400 as one embodiment of the string-matching engine 208 included in the co-processor 206. The string matching engine 400 includes a k-way hashing unit 402 arranged to receive the character string 230 copied from the incoming data stream 224, a filtering unit 406 having a hash lookup table 408 and a selector unit 410 that, in combination with the k-way hash of the character string 230, generates a set of pointers 412 that are used to select character strings stored corresponding memory locations in a string dictionary 414 as part of a secondary memory unit 416 by a matching unit 418. The corresponding character strings are fetched from the memory addresses indicated by the memory pointers 412 and forwarded byte by byte to a comparator unit 420. At the comparator unit 420, the byte-wise character string fetched from the string dictionary 414 is then byte-wise compared to the original character string 230. If during the comparison, if any of the compared bytes do not match, then a flag unit 422 generates a no match signal 424, otherwise, if all the compared bytes match, then the flag unit 422 generates a match signal 426 that is typically forwarded to the CPU 204 for further action consistent with resident security protocols.

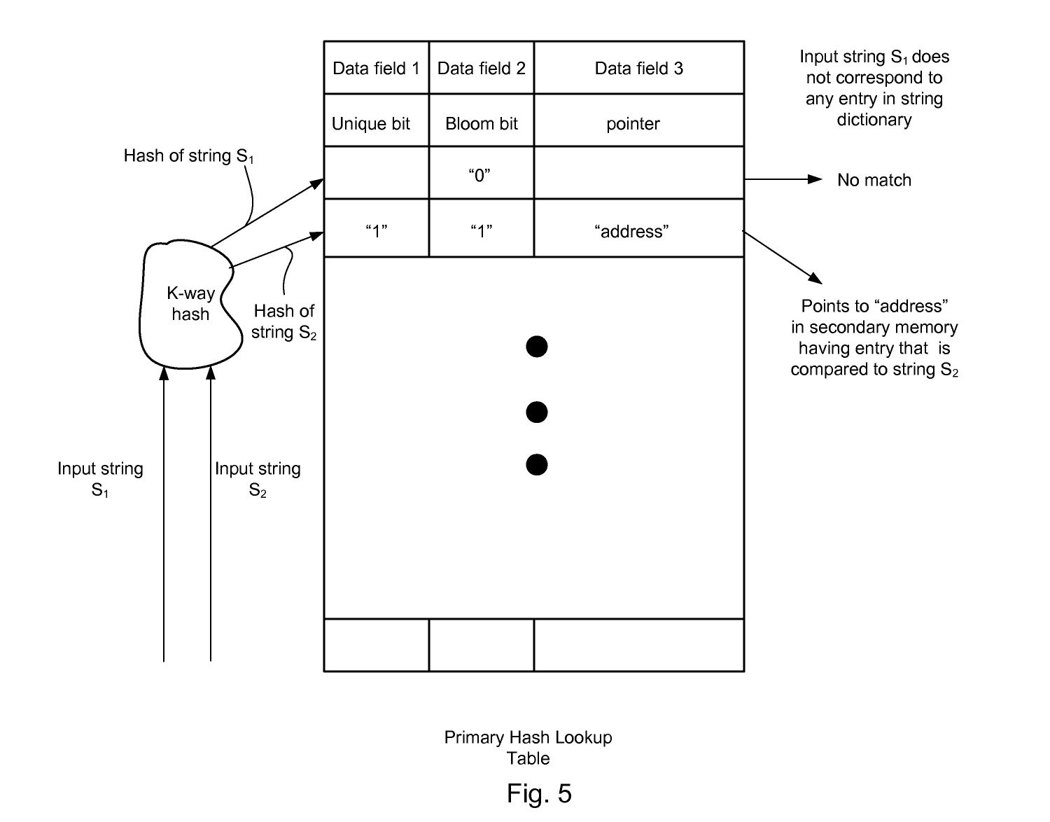

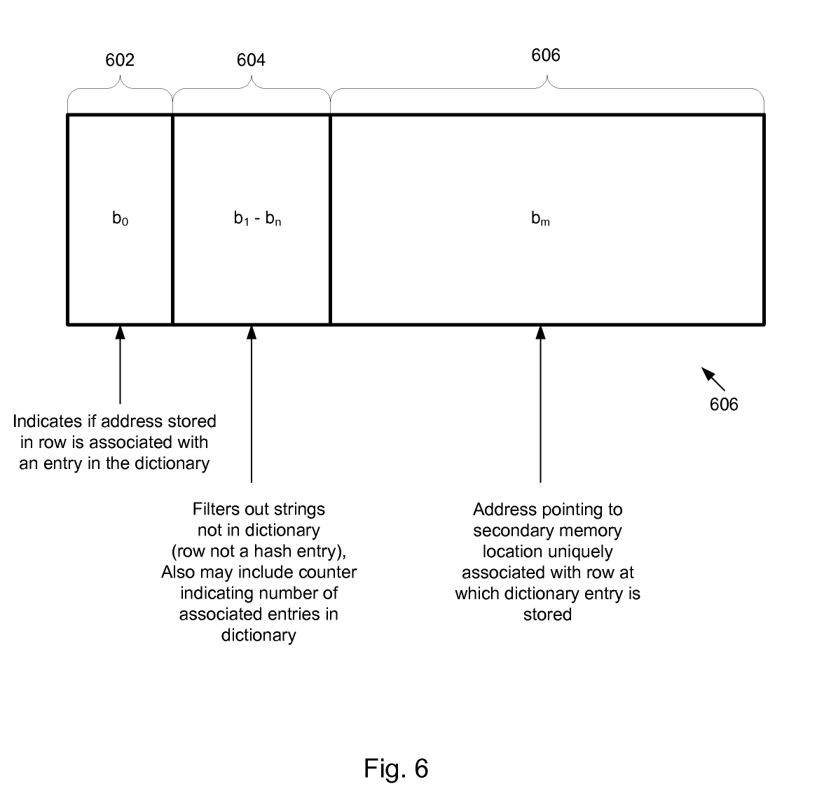

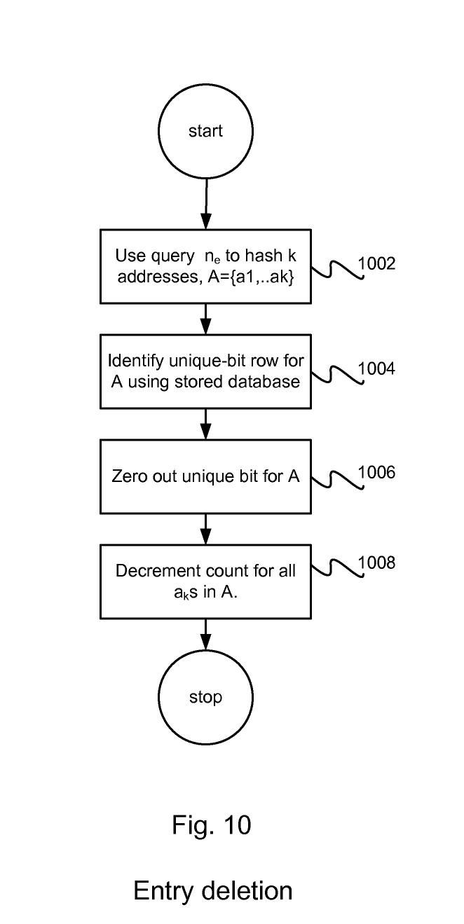

FIG. 5 shows an embodiment 500 of the primary hash look up table 500 in the form of memory space arranged as m rows where each row is capable of storing n data bits an example of which is shown in FIG. 6 as a memory row 600. As shown, the memory row 600 has a first field 602 having a bit location b₀ (referred to as a unique bit) that is used to mark the use of that particular row address as a unique location corresponding to a particular dictionary entry. A second field 604 includes a second bit (or collection of bits (b₁ to bₓ)) that may be used to indicate if the memory row 600 was hashed to by any other element of the string dictionary and, optionally, counter bits that could be counted up to the maximum value whenever an entry in the string dictionary points to this particular row address thereby enabling the deletion of dictionary entries in constant time. (An example of such a process is shown in FIG. 10 described in more detail below.) A third field 606 includes a set of bits (bₓ₊₁ to b_{x+w}) that stores the address A pointing to the string dictionary where the input key (or key-fingerprint) and any data associated with the key is stored.

Referring back to FIG. 5, during lookup, if any of the collection of bits {bₓ . . . b₁} is 0, the associated input is definitely not a member of the string dictionary (thereby acting as a first filter along the lines of the Bloom filter discussed above and henceforth is referred to as a Bloom bit for simplicity). On the other hand, if the Bloom bit is not 0, then the associated input may be a string dictionary entry and the string matching engine 202 identifies the subset of addresses (out of the k addresses generated by the k hash functions) for which b₀=1. This requires that only k bits are fetched from the primary lookup table initially, followed by a fetch of b_{w} bits (bₓ₊₁ . . . b_{x+w}) of the addresses at which b₀ is 1. The input key/key-fingerprint is then compared against the key/key-fingerprint stored in the string dictionary locations at the addresses where {bx . . . b1} is 1. If a match is found, the input key is a member of the string dictionary, else it is not.

It should be noted that the comparisons to the values in the secondary memory (string dictionary) are interleaved at the granularity of a byte (or similar small number). As a result, the expected number of bits to be fetched of the non-matching values in the secondary memory will be much smaller than the total number of stored bits. Also, for the typical lookup, the expected number of unique locations in the hash lookup table (for which b₀=1), will be small. The total number of unique locations in the hash lookup table is equal to |S|. As a result, as m/n (number of rows in the hash lookup table divided by |S|) approaches the number of hash functions, k, the number of unique locations encountered in the typical lookup will approach 1. In this way, a low memory collision-free hash-based look up scheme with low average case bandwidth and power requirements are provided where the worst-case bandwidth requirements depend only on the width of the dictionary words.

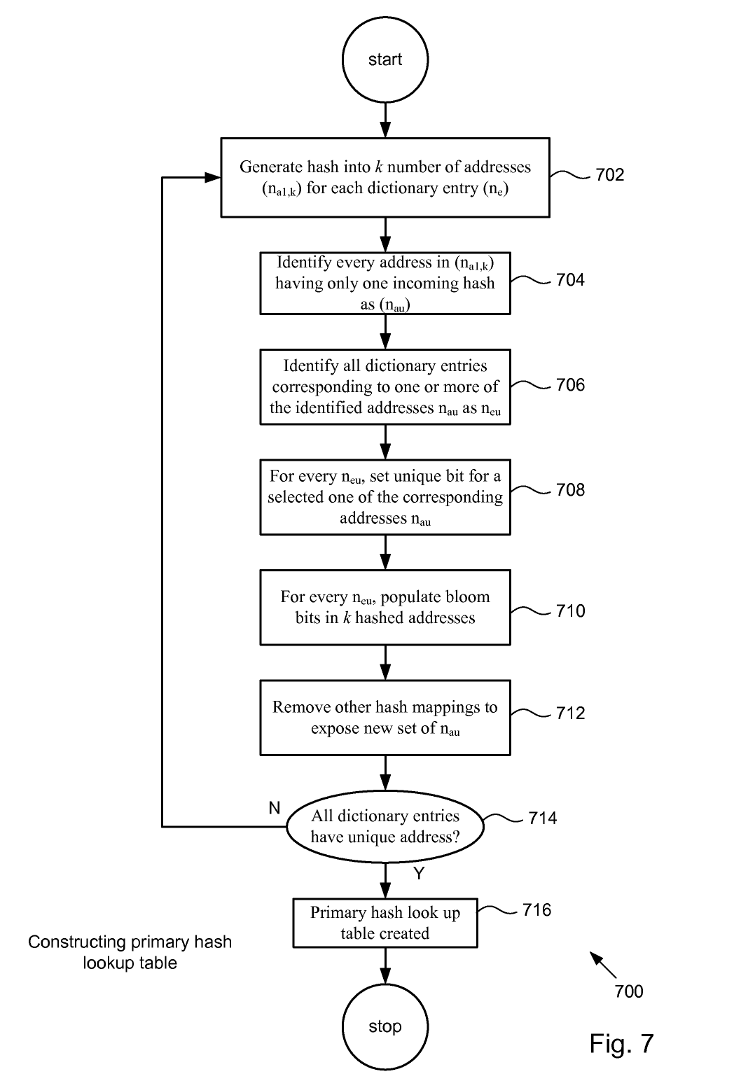

FIG. 7 shows a flowchart detailing a process 700 for creating the hash lookup table 500 in accordance with an embodiment of the invention. The process 700 starts at 702 by generating a hash into k number of addresses (n_{al,k}) for each dictionary entry (nₑ) while at 704 every address in (n_{al,k}) having only one incoming hash is identified as (nₐᵤ). At 706, all dictionary entries corresponding to one or more of the identified addresses nₐᵤ are identified as nₑᵤ and at 708 a unique bit for a selected one of the corresponding addresses nₐᵤ is set for every nₑᵤ. For every nₑᵤ, bloom bits in k-hashed addresses are set at 710 and at 712 other hash mappings are removed to expose new set of nₐᵤ. At 714, if all dictionary entries have a unique address, then the primary hash lookup table is considered created at 716, otherwise, control is passed back to 702 and the process 700 continues until all dictionary entries are determined to have a unique address in the primary hash lookup table.

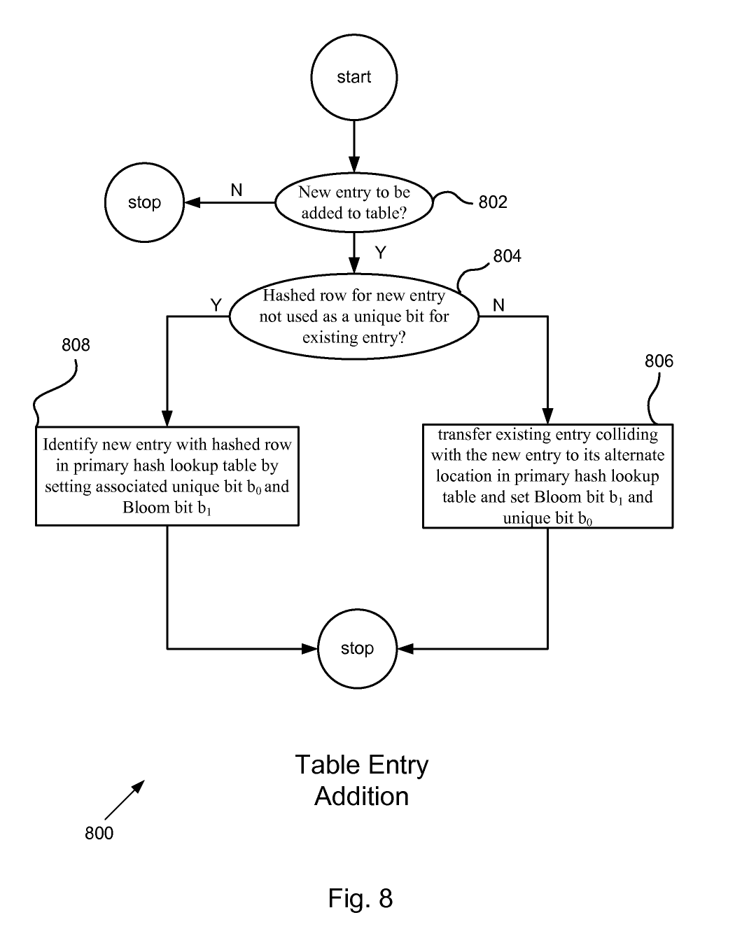

FIG. 8 illustrates a process 800 for updating the primary hash lookup table when a new entry is added to the string dictionary in accordance with an embodiment of the invention. Accordingly, the process 800 begins at 802 by determining if a new dictionary string has been added to the string dictionary. If a new dictionary string has been added, then at 804 if a hashed row for the new entry is not used as a unique bit for the existing entry, then the new entry is identified with the hashed row in the hash lookup table and the associated Bloom bit b₁ and unique bit b₀ are set at 806. Otherwise, at 808, the existing entry is transferred to an alternate location in the primary hash lookup table and the associated Bloom bit b₁ and unique bit b₀ are set and the new entry replaces the now transferred entry at 810.

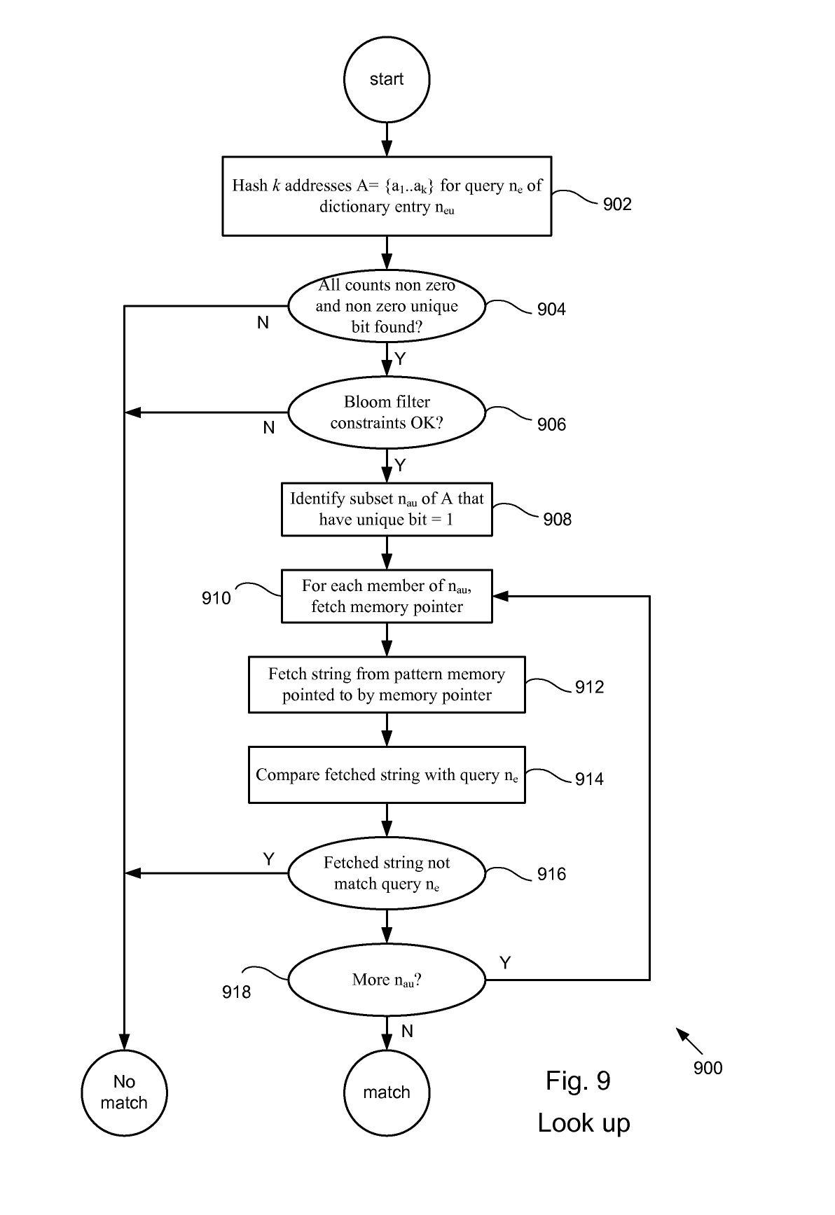

FIG. 9 shows a process 900 for determining if a character string of fixed length N (where N can be an arbitrary number determined at the time of creation) is stored in a string dictionary in accordance with an embodiment of the invention. The process 900 starts at 902 by performing a k-way hash of the character string. If at 904 all counts are non-zero and a non-zero unique bit is not found, then the character string does not match any of the entries in the string dictionary and the a no match signal is issued, otherwise, at 906, a determination is made if all the Bloom filter constraints have been met. If any of the Bloom bits are determined to be 0, then the Bloom filter constraints have not been met and the character string is not included in the string dictionary and the no match signal is issued, otherwise, a subset of the hash addresses having a unique bit set to 1 are identified at 908. In this way, at least one of these addresses corresponds with the matching character string in the string dictionary. Therefore, at 910, for each subset of hash addresses identified at 908, a pointer stored therein that points to a location in the string memory at which the candidate character string is stored is fetched. At 912, the candidate character strings are fetched from the string dictionary and at 914, each of the candidate character strings is compared to the incoming character string. At 914, if the candidate character string does not match the incoming character string, then the no match signal is provided otherwise at 916 the comparing continues until all identified addresses have been checked after which a match signal is issued.

FIG. 10 shows a flowchart detailing a process 1000 for deleting an entry in accordance with an embodiment of the invention. The process 1000 begins at 1002 by using the query ne to hash A addresses {a₁ . . . aₖ) followed at 1004 by using a stored database to identify the unique bit row for A. At 1006, the unique bit for A is then zero'd out and at 1008 the counter for all member of A are decremented. In deployments where entry deletion is done offline and not on the time critical paths, one bit suffices for this purpose. The counter bits are only kept in the offline database to enable easy deletion, and the match memory in the client only keeps one bit to indicate if that address was hashed to by any element. In addition, it is also possible to use more bits such that the combination of these bits in the hashed addresses provides further identification of the absence of a match.

The invention provides a number of advantages over the prior art, in particular, the Bloom bits reduce the need for further lookup once a mismatch has been established. The address stored in hash lookup table needs to be fetched and further lookup in the pattern memory only when the unique bit is set to one thereby considerably reducing the need to perform lookups in the string dictionary. In a particularly useful embodiment, a dual-memory architecture is used such that the hash lookup table stores only the addresses for further look up for establishing an actual match thereby allowing the hash lookup table to have a larger number of rows (hash buckets), and thereby, bring closer to 1 the expected number of rows with unique bit set to 1, and thereby, the number of rows to be looked up in the sting dictionary. As a result, the architecture represents a high-bandwidth lookup scheme in which the expected latency of lookup for a matching input requires fetching one pattern from the memory, with the worst case latency being bounded by k (˜5) pattern fetches.

Further, the memory fetches from the string dictionary are a fine granularity of possibly a byte so that a mismatch can be declared as soon as the first mismatching byte is identified and the remainder of the row is not fetched. Still, further, the memory fetches from the string dictionary can be interleaved so that character comparison can be done in parallel for the rows to be looked up. With its emphasis on minimizing the memory and number of memory fetches, the inventive architecture also represents a scheme for minimizing the energy consumption per lookup relative to competing schemes. The architecture supports an O(1) delete from the dictionary and an expected O(1) time for incremental adds.

Embodiments of the invention, including the apparatus disclosed herein, can be implemented in digital electronic circuitry, or in computer hardware, firmware, software, or in combinations of them. Apparatus embodiments of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. Embodiments of the invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language.

Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

A number of implementations of the invention have been described. Nevertheless, it will be understood that various modifications may be made without departing from the spirit and scope of the invention. Accordingly, other embodiments are within the scope of the following claims.

What is claimed is:

1. String matching, comprising:
k-way hashing a first string;
locating k hash locations in a first memory based upon the k-way hashing;
identifying a sub-set of the k hash locations having a corresponding string stored in a second memory;
comparing the first string to the stored strings; and
issuing a match signal when the first string and at least one of the stored strings matches.

2. String matching as recited in claim 1, wherein the first memory is a look up table comprising:
a plurality of rows arranged to store a number of data bits.

3. String matching as recited in claim 2, wherein the number of data bits comprises:
a first data field for storing a Bloom bit;
a second data field for storing a unique bit that is used to determine which of the k hash locations hold a useful address; and
a third data field for storing a pointer arranged to point to an address in the second memory used to store the corresponding string, wherein if any of the Bloom bits associated with the k hash locations is zero, then the first string does not match any of the stored strings, and wherein the sub-set of k hash locations are those k hash locations having non-zero Bloom bits.

4. String matching as recited in claim 3, wherein the second memory is a string dictionary used to store a plurality of strings.

5. String matching as recited in claim 4, wherein the comparing the first string to the stored strings comprises:
fetching the stored string from the string dictionary using the pointer, wherein fetches from the string dictionary are interleaved over the addresses pointed to from the first memory.

6. String matching as recited in claim 5, wherein the comparing the first string to the stored strings comprises; (a) storing a byte of the first string in a first buffer unit;
(b) storing a corresponding byte of the candidate string in a second buffer unit;
(c) comparing the fetched byte of the first string and the fetched byte of the candidate string in a comparator unit; and
if the bytes match, then repeating (a)-(c) until the compared bytes do not match, then
issuing a no match signal, otherwise
issuing a match signal.

7. String matching as recited in claim 6, wherein the second data field further comprises:
a counter bit arranged to indicate the number of dictionary strings stored in the string dictionary that correspond to the address.

8. String matching as recited in claim 7, wherein when a string entry in the dictionary string is deleted, then the corresponding counter bit is decremented.

9. String matching as recited in claim 1, wherein a string-matching engine performs the string matching and wherein the string is selected from a group comprising: a set of characters, a set of numbers, a set of data bits.

10. String matching as recited in claim 9, wherein the string-matching engine is incorporated into a co-processor unit.

11. String matching as recited in claim 9, wherein the co-processor unit is an integrated circuit.

12. String matching as recited in claim 11, wherein the integrated circuit is incorporated into a thin client device.

13. String matching as recited in claim 12, wherein the thin client device is a personal portable communication device.

14. String matching as recited in claim 13, wherein the personal portable communication device is a cell phone.

15. Computer program product executable by a processor for string matching, comprising:
computer code for k-way hashing a first string;
computer code for locating k hash locations in a first memory based upon the k-way hashing;
computer code for identifying a sub-set of the k hash locations having a corresponding string stored in a second memory;
computer code for comparing the first string to the stored strings;
computer code for issuing a match signal when the first string and at least one of the stored strings matches; and
computer readable medium for storing the computer code.

16. Computer program product as recited in claim 15, wherein the first memory is a look up table comprising:
a plurality of rows arranged to stored a number of data bits.

17. Computer program product as recited in claim 16, wherein the number of data bits comprises;
a first data field for storing a Bloom bit;
a second data field for storing a unique bit that is used to determine
which of the k hash locations hold a useful address; and
a third data field for storing a pointer arranged to point to an address in the second memory used to store the corresponding string, wherein if any of the Bloom bits associated with the k hash locations is zero, then the first string does not match any of the stored strings, and wherein the sub-set of k hash locations are those k hash locations having non-zero Bloom bits.

18. Computer program product as recited in claim 15, wherein the second memory is a string dictionary used to store a plurality of strings.

19. Computer program product as recited in claim 15, wherein the comparing the first string to the stored strings comprises;
computer program product fetching the stored string using the pointer.

20. Computer program product as recited in claim 19, wherein the comparing the first string to the stored strings comprises;
computer code for storing a byte of the first string in a first buffer unit;
computer code for storing a corresponding byte of the candidate string in a second buffer unit;
computer code for comparing the fetched byte of the first string and the fetched byte of the candidate string in a comparator unit; and
computer code for issuing a no match signal if not all the bytes match otherwise issuing a match signal.

21. Computer program product as recited in claim 15, wherein the second data field further comprises:
a counter bit arranged to indicate the number of dictionary strings stored in the string dictionary that correspond to the address.

22. Computer program product as recited in claim 21, wherein when a string entry in the dictionary string is deleted, then the corresponding counter bit is decremented.

23. Computer program product as recited in claim 15, wherein a string-matching engine performs the string matching.

24. Computer program product as recited in claim 23, wherein the string-matching engine is incorporated into a co-processor unit.

25. Computer program product as recited in claim 24, wherein the co-processor unit is an integrated circuit.

26. Computer program product as recited in claim 25, wherein the integrated circuit is incorporated into a thin client device.

27. Computer program product as recited in claim 26, wherein the thin client device is a personal portable communication device.

28. Computer program product as recited in claim 27, wherein the personal portable communication device is a cell phone.

29. An apparatus for string matching, comprising:
means for k-way hashing a first string;
means for locating k hash locations in a first memory based upon the k-way hashing;
means for identifying a sub-set of the k hash locations having a corresponding string stored in a second memory;
means for comparing the first string to the stored strings; and
means for issuing a match signal when the first string and at least one of the stored strings matches.

30. An apparatus as recited in claim 29, wherein the first memory is a look up table comprising:
a plurality of rows arranged to stored a number of data bits.

31. An apparatus as recited in claim 30, wherein the number of data bits comprises;
a first data field for storing a Bloom bit;
a second data field for storing a unique bit that is used to determine which of the k hash locations hold a useful address; and
a third data field for storing a pointer arranged to point to an address in the second memory used to store the corresponding string, wherein if any of the Bloom bits associated with the k hash locations is zero, then the first string does not match any of the stored strings, and wherein the sub-set of k hash locations are those k hash locations having non-zero Bloom bits.

32. An apparatus as recited in claim 29, wherein the second memory is a string dictionary used to store a plurality of strings.

33. An apparatus as recited in claim 29, wherein the comparing the first string to the stored strings comprises:
fetching the stored string using the pointer.

34. An apparatus as recited in claim 33, wherein the comparing the first string to the stored strings comprises;
means for storing a byte of the first string in a first buffer unit;
means for storing a corresponding byte of the candidate string in a second buffer unit;
means for comparing the fetched byte of the first string and the fetched byte of the candidate string in a comparator unit; and
means for issuing a no match signal if any of the compared bytes do not match, otherwise issuing a match signal.

35. An apparatus as recited in claim 29, wherein the second data field further comprises:
a counter bit arranged to indicate the number of dictionary strings stored in the string dictionary that correspond to the address.

36. An apparatus as recited in claim 35, wherein when a string entry in the dictionary string is deleted, then the corresponding counter bit is decremented.

37. An apparatus as recited in claim 29, wherein a string-matching engine performs the string matching.

38. An apparatus as recited in claim 37, wherein the string-matching engine is incorporated into a co-processor unit.

39. An apparatus as recited in claim 38, wherein the co-processor unit is an integrated circuit.

40. An apparatus as recited in claim 39, wherein the integrated circuit is incorporated into a thin client device.

41. An apparatus as recited in claim 40, wherein the thin client device is a personal portable communication device.

42. An apparatus as recited in claim 41, wherein the personal portable communication device is a cell phone.
